(19) United States
(12) Patent Application Publication
(10) Pub. No.: US 2016/0032787 A1
(43) Pub. Date: Feb. 4, 2016

(54) SOLID OXIDE CELL SYSTEM AND METHOD FOR MANUFACTURING THE SAME

(71) Applicant: Korea Institute of Science and Technology, Seoul (KR)

(72) Inventors: Jongsup HONG, Seoul (KR); Hyoungchul KIM, Seoul (KR); Kiyong AHN, Seoul (KR); Kyung Joong YOON, Seoul (KR); Ji-Won SON, Seoul (KR); Jong Ho LEE, Seoul (KR); Hae June JE, Seoul (KR); Byung Kook KIM, Seoul (KR)

(73) Assignee: KOREA INSTITUTE OF SCIENCE AND TECHNOLOGY, Seoul (KR)

(21) Appl. No.: 14/814,057

(22) Filed: Jul. 30, 2015

(30) Foreign Application Priority Data
Jul. 31, 2014 (KR) 10-2014-0098052

(51) Int. Cl. F01K 23/10; F02C 6/18; H01M 16/00; C25B 15/08; C25B 1/02; C25B 1/00

(52) U.S. Cl. CPC F01K 23/10; C25B 1/02; C25B 1/00; H01M 16/003; C25B 15/08; F02C 6/18

(57) ABSTRACT

Provided are a solid oxide cell (SOC) system producing a synthetic gas by using a waste gas discharged from a power plant, or the like, and a method for controlling the same. The SOC system includes i) a first power plant configured to provide a waste gas and first electrical energy, ii) a second power plant configured to provide second electrical energy using an energy source different from that of the first power plant, and iii) a solid oxide cell (SOC) connected to the first power plant and the second power plant, configured to receive the waste gas and the second electrical energy to manufacture carbon monoxide and hydrogen, and providing the carbon monoxide and the hydrogen to the first power plant.

### CROSS-REFERENCE TO RELATED APPLICATION

This application claims priority to and the benefit of Korean Patent Application No. 10-2014-0098052 filed in the Korean Intellectual Property Office on Jul. 31, 2014, the entire contents of which are incorporated herein by reference.

### BACKGROUND OF THE INVENTION

(a) Field of the Invention

The present invention relates to a solid oxide cell system and a method for controlling the same. More particularly, the present invention relates to a solid oxide cell system for converting electrical energy produced from nighttime surplus electrical power or renewable energy sources into synthetic gas which has a high added value by using low-grade heat and waste gas discharged from power plants or producing electrical power, or the like.

(b) Description of the Related Art

A greenhouse effect due to the use of fossil fuels such as coal or oil has caused a lot of environmental problems such as large-scale natural disasters, a rise in sea levels, and a change in fish species all over the world. Thus, the development of technologies for processing and utilizing carbon dioxide discharged from conventional fossil fuels-based power plants, main sources of carbon dioxide, has gained importance. On the other hand, techniques regarding renewable energy in order to reduce the formation of carbon dioxide, such as fuel cells, solar cells, and wind power energy, have actively been developed.

Such renewable energy is largely focused on production of electrical energy. However, renewable energy has a problem in that non-uniform generation of electrical power results from fluctuation in energy sources. In addition, electrical energy produced at night in power plants or the like is not in great demand, and thus it is discarded, rather than being used. Thus, a scheme of stably supplying electrical power from renewable energy and using surplus energy without discarding it is required. Furthermore, a great deal of carbon dioxide and high-grade thermal energy are discarded through waste gas or the like in power plants, which are thus required to be effectively processed and recuperated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a solid oxide cell (SOC) system having advantages of effectively utilizing surplus electrical power and renewable energy, and converting electrical energy into chemical energy and storing the converted chemical energy or producing electrical power. The present invention has also been made in an effort to provide a method for controlling the foregoing SOC system.

An exemplary embodiment of the present invention provides a solid oxide cell (SOC) system including: i) a first power plant configured to provide waste gas and first electrical energy; ii) a second power plant configured to provide second electrical energy using an energy source different from that of the first power plant; and iii) a solid oxide cell (SOC) connected to the first power plant and the second power plant, configured to receive the waste gas and the second electrical energy to manufacture carbon monoxide and hydrogen, and provide the carbon monoxide and the hydrogen to the first power plant.

The SOC system may further include a synthetic gas repository connected to the SOC and configured to store the synthetic gas manufactured by using the carbon monoxide and the hydrogen. The second power plant may be one or more selected from the group consisting of a solar power plant, a wind power plant, a geothermal power plant, a fuel cell power plant, and a tidal power plant, and the SOC may receive the first electrical energy.

The first power plant may include: i) a gas turbine; and ii) a steam turbine connected to the gas turbine and configured to receive steam produced by waste heat of the gas turbine. The gas turbine may include: i) a compressor configured to take in air from the outside and provide compressed air; and ii) a combustor connected to the compressor to provide compressed air, and connected to the SOC to receive the carbon monoxide and the hydrogen from the SOC and combust the received carbon monoxide and hydrogen, and configured to discharge a combustion gas generated according to the combustion.

The SOC system may further include a heat exchanger configured to connect the gas turbine and the steam turbine. The heat exchanger may be connected to the combustor, configured to manufacture steam supplied to the steam turbine by the combustion gas, and connected to the SOC to supply the carbon dioxide and the steam to the SOC. The waste gas may be discharged from the steam turbine.

The SOC system may further include an exhaust gas purifier configured to connect the heat exchanger and the SOC, purify a waste gas discharged from the heat exchanger, and supply the purified gas to the SOC. The exhaust gas purifier may extract nitrogen from the waste gas and provide the extracted nitrogen as a purging gas to the SOC.

Another exemplary embodiment of the present invention provides a solid oxide cell (SOC) system including: a first power plant configured to provide waste gas and first electrical energy; a second power plant configured to provide second electrical energy using an energy source different from that of the first power plant; a solid oxide cell (SOC) connected to the first power plant and the second power plant, configured to receive second electrical energy, and providing third electrical energy; and a synthetic gas repository connected to the first power plant and the SOC and configured to provide a synthetic gas to the first power plant and the SOC. The SOC may receive the first electrical energy.

Yet another exemplary embodiment of the present invention provides a method for controlling a solid oxide cell (SOC) system, including: i) providing, by a first power plant, a waste gas and first electrical energy; ii) providing, by a second power plant, second electrical energy by using an energy source different from that of the first power plant; iii) manufacturing, by a solid oxide cell (SOC) connected to the first power plant and the second power plant, carbon monoxide and hydrogen upon receiving the waste gas and the second electrical energy; and iv) providing, by the SOC, the manufactured carbon monoxide and the hydrogen to the first power plant.

The method may further include providing the first electrical energy to the SOC. The method may further include storing, by the synthetic gas repository connected to the SOC, a synthetic gas manufactured by using the carbon monoxide and the hydrogen.

In the manufacturing of carbon monoxide and hydrogen, the SOC may operate when an amount of sunshine is less than a preset value. Further, in the manufacturing of carbon monoxide and hydrogen, the SOC may operate when an atmospheric temperature is within a preset range.

Still another exemplary embodiment of the present invention provides a method for controlling a solid oxide cell (SOC) system, including: i) providing, by a first power plant, a waste gas and first electrical energy; ii) providing, by a second power plant, second electrical energy by using an energy source different from that of the first power plant; iii) receiving, by a solid oxide cell (SOC) connected to the first power plant and the second power plant, second electrical energy, and providing third electrical energy; and iv) providing, by a synthetic gas repository connected to the first power plant and the SOC, a synthetic gas to one or more of the first power plant and the SOC.

In the providing of third electrical energy, the SOC may operate when an amount of sunshine is equal to or greater than a preset value. In the providing of third electrical energy, the SOC may operate when an atmospheric temperature is higher than or lower than a preset range.

According to an exemplary embodiment of the present invention, a synthetic gas may be manufactured from waste energy by using the SOC system. In particular, since a synthetic gas may be manufactured from carbon dioxide, the carbon dioxide, a major contributor to global warming, may be utilized as an energy source. Also, a synthetic gas may be manufactured by using electrical energy which is produced on an irregular basis in wind power generation or tidal power generation, or electrical energy which remains, rather than being utilized, at night in a power plant, or the like. Electrical power may also be produced by using the SOC.

### BRIEF DESCRIPTION OF THE DRAWINGS

FIG. 1 is a schematic conceptual view of a solid oxide cell (SOC) system according to a first exemplary embodiment of the present invention.

FIG. 2 is a schematic view illustrating an operational state of the SOC system of FIG. 1.

FIG. 3 is a schematic conceptual view of an SOC system according to a second exemplary embodiment of the present invention.

FIG. 4 is a schematic view illustrating an operational state of the SOC system of FIG. 3.

FIG. 5 is a schematic perspective view of a solid oxide cell included in the SOC systems according to the first and second exemplary embodiments of the present invention.

### DETAILED DESCRIPTION OF THE EXEMPLARY EMBODIMENTS

It will be understood that when an element such as a layer, film, region, or substrate is referred to as being “on” another element, it can be directly on the other element or intervening elements may also be present. In contrast, when an element is referred to as being “directly on” another element, there are no intervening elements present.

Technical terms used in the present specification are used only in order to describe specific exemplary embodiments rather than limiting the present invention. The terms of a singular form may include plural forms unless referred to the contrary. It will be further understood that the terms “comprise” and/or “comprising,” when used herein, specify the presence of stated features, integers, steps, operations, elements, and/or components, but do not preclude the presence or addition of one or more other features, regions, integers, steps, operations, elements, components, and/or groups thereof.

Also, relative terms such as “under” or “upper” may be used to describe relationships of certain elements to other elements as depicted in the drawings. Such relative terms may be understood as intending the inclusion of other meanings or operations of a device used in addition to meanings intended in the drawings.

For example, when a device is turned over in the drawings, elements illustrated to be present above other elements may be oriented under the foregoing other elements. Thus, for example, the term “on” may include both directions of “under” and “on” relying on a particular direction of drawings. A device may be rotated by 90 degrees or other angles, and relative terms used in this disclosure may be interpreted accordingly.

Unless indicated otherwise, it is to be understood that all the terms used in the specification, including technical and scientific terms, have the same meaning as those that are understood by those skilled in the art to which the present invention pertains. It must be understood that the terms defined by the dictionary are identical with the meanings within the context of the related art, and they should not be ideally or excessively formally defined unless the context clearly dictates otherwise.

A term “solid oxide cell (SOC)” used hereinafter refers to every device producing electrical or chemical energy through an electrochemical reaction of a solid oxide. Thus, the solid oxide cell is interpreted as including every device producing chemical energy such as a fuel gas through an electrochemical reaction such as an electrochemical cell, or the like, as well as a device producing electrical energy such as a fuel cell.

The present invention will be described more fully hereinafter with reference to the accompanying drawings, in which exemplary embodiments of the invention are shown. However, as those skilled in the art would realize, the described exemplary embodiments may be modified in various different ways, all without departing from the spirit or scope of the present invention.

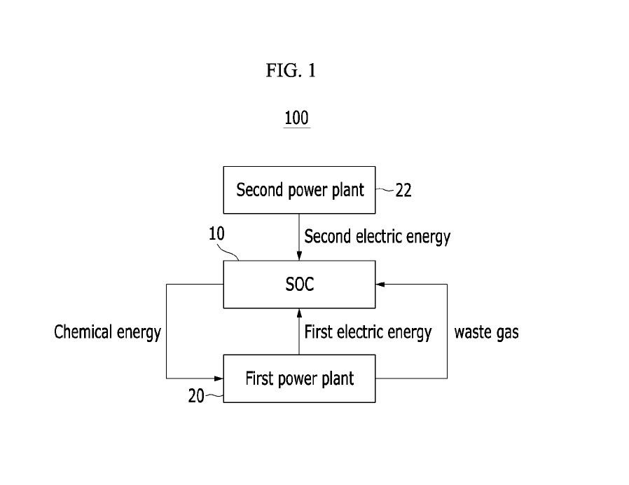

FIG. 1 is a schematic conceptual view of a solid oxide cell (SOC) system 100 according to a first exemplary embodiment of the present invention. A structure of the SOC system 100 of FIG. 1 merely illustrates the present invention, and the present invention is not limited thereto. Thus, the structure of the SOC system 100 may also be modified to have any other form.

As illustrated in FIG. 1, the SOC system 100 includes an SOC 10, a first power plant 20, and a second power plant 22. In addition, the SOC system 100 may further include other components as necessary.

The first power plant 20 discharges a waste gas and first electrical energy. The first power plant 20 may be a thermoelectric power plant or a nuclear power plant. The thermoelectric power plant may be a power plant using only a gas turbine or a power plant using both a gas turbine and a steam turbine. The SOC 10 is connected to the first power plant 20. The SOC 10 receives a waste gas, i.e., a gas including steam and carbon dioxide, from the first power plant 20, and manufactures carbon monoxide and hydrogen. The SOC 10 supplies chemical energy, i.e., the manufactured carbon monoxide and hydrogen, to the first power plant 20. Thus, the first power plant 20 may produce electrical power including first electrical energy by using the carbon monoxide and hydrogen as base materials.

Meanwhile, the second power plant 22 provides second electrical energy using a different energy source from that of the first power plant 20. For example, the second power plant 22 may use a new renewable energy source. The new renewable energy source may be solar heat, wind power, a fuel cell, or tidal power, and thus the second power plant 22 may be a solar power plant, a wind power plant, a geothermal power plant, a fuel cell power plant, or a tidal power plant. In this case, the second electrical energy supplied from the second power plant 22 to the SOC system 100 may not be uniform or may be slightly insufficient, and thus the first electrical energy may be additionally provided from the first power plant 20 to the SOC system 100. In addition to the aforementioned new renewable energy source, any other new renewable energy source may also be used.

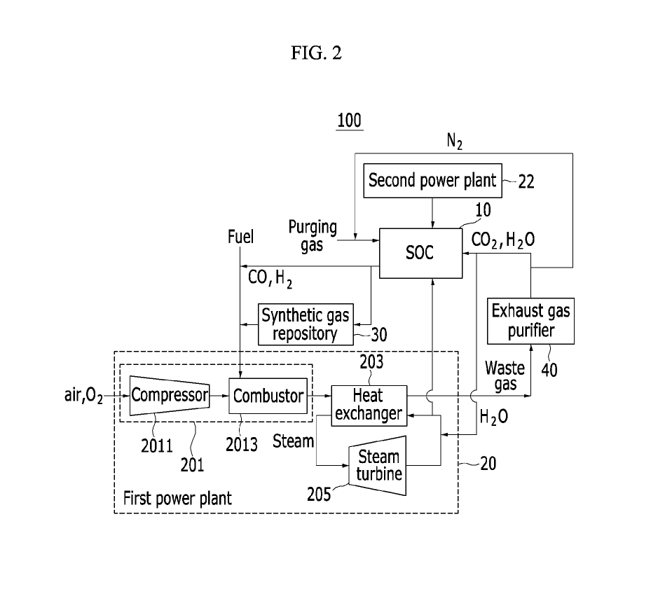

FIG. 2 is a schematic view illustrating an operational state of the SOC system 100 of FIG. 1. The operational state of the SOC system 100 illustrated in FIG. 2 specifies the operational state of the SOC system 100 of FIG. 1. The operational state of the SOC system 100 of FIG. 2 is merely illustrative, and the present invention is not limited thereto. Thus, the operational state of the SOC system 100 may also be modified to other forms.

The SOC system 100 of FIG. 2 shows an operational state at night or in spring or autumn. That is, the SOC system 100 operates at night when an amount of sunshine is less than a preset value or when an atmospheric temperature is within a preset range. In this case, since demand for electrical power is not great, electrical energy may be converted into chemical energy by using the SOC 10 as an electrochemical cell. Here, the aforementioned preset value may range from 1500 Kwh/m² to 2000 Kwh/m²

That is, when the aforementioned amount of sunshine is less than the preset value, the SOC system 100 operates. Also, the aforementioned atmospheric temperature may range from 10° C. to 25° C. The SOC system 100 operates within the aforementioned atmospheric temperature range.

As illustrated in FIG. 2, the SOC system 100 includes the SOC 10, the first power plant 20, the second power plant 22, a synthetic gas repository 30, and an exhaust gas purifier 40. In addition, the SOC system 100 may further include other devices.

The first power plant 20 includes a gas turbine 201, a heat exchanger 203, and a steam turbine 205. The gas turbine 201 includes a compressor 2011 and a combustor 2013. The steam turbine 205 is connected to the gas turbine 201 through the heat exchanger 203. Air or oxygen may be introduced to the compressor 2011, compressed by the compressor 2011, and subsequently supplied to the combustor 2013. The combustor 2013 mixes the oxygen or air supplied from the compressor 2011 with fuel to generate an exhaust gas having a high temperature. The exhaust gas discharged from the combustor 2013 is expanded and supplied to the heat exchanger 203. The exhaust gas introduced to the heat exchanger 203 re-heats low temperature steam discharged from the steam turbine 205 and supplies the re-heated steam to the steam turbine 205. For example, a heat recovery steam generator (HRSG) may be used as the heat exchanger 203.

A waste gas discharged from the heat exchanger 203 is supplied to the exhaust gas purifier 40. The exhaust gas purifier 40 may purify the waste gas and supply the purified gas to the SOC 10. That is, the exhaust gas purifier 40 purifies the waste gas and supplies carbon dioxide and steam as base materials to the SOC.

Meanwhile, electrical power irregularly produced by the second power plant 22 or electrical power produced at night by the first power plant 20 but without a consumer is discarded as is, causing a waste of resource. That is, electrical energy has characteristics that it is consumed as soon as being produced, and thus, a problem arises in that the electrical energy produced in the foregoing case is discarded. Thus, in the first exemplary embodiment of the present invention, in order to solve the problem, electrical energy is converted into chemical energy by using the SOC 10, that is, into an energy form that may be consumed afterwards, rather than simultaneous consumption. That is, since the SOC 10 electrolyzes carbon dioxide or steam by using the foregoing electrical energy to convert it into chemical energy of carbon monoxide or hydrogen, energy efficiency may be significantly increased.

Nitrogen purified and discharged from the exhaust gas purifier 40 may be supplied as a purging gas to the SOC 10. Thus, when an operation of the SOC 10 is stopped, the purging gas may be supplied to the SOC 10 to discharge non-combustion gas accumulated within the SOC 10 to the outside. Meanwhile, steam discharged from the exhaust gas purifier 40 may be supplied to the heat exchanger 203 to further complement steam required for driving the steam turbine 205.

Although not shown in FIG. 2, the heat exchanger 203 and the SOC 10 may be thermally grouped. Thus, heat loss of the SOC system 200 may be minimized.

Meanwhile, unlike the case of FIG. 2, an integrated gasification combined cycle (IGCC) or an oxygen fuel generation system may not require the exhaust gas purifier 40. That is, since impurities are not included in a waste gas discharged from the heat exchanger 203, the waste gas may be directly used as a base material in the SOC 10. In this case, only pure oxygen needs to be introduced to the compressor 2011, and steam discharged from the steam turbine 205 or a waste gas discharged from the heat exchanger 203 may be directly supplied to the SOC 10.

The SOC 10 discharges carbon monoxide and hydrogen, or a synthetic gas using these materials as base materials, to the outside through an electrochemical reaction. The synthetic gas may be stored in the synthetic gas repository 30 and may be extracted to be used whenever necessary. Carbon monoxide and hydrogen or the synthetic gas using these materials as base materials may be supplied as fuel to the combustor 2013. Here, the SOC 10 may supply carbon monoxide and hydrogen or the synthetic gas using these materials as base materials directly to the combustor 2013.

The synthetic gas repository 30 connects the first power plant 20 and the SOC 10. The synthetic gas repository 30 stores the synthetic gas manufactured by using carbon monoxide and hydrogen. That is, since the synthetic gas repository 30 stores a synthetic gas such as methane gas or the like, surplus electrical power may be converted into utilizable chemical energy at any time

The synthetic gas repository 30 may be used when necessary in order to control a flow of fuel. That is, in a case in which an amount of fuel supplied to the combustor 2013 is too excessive, a flow of fuel may be reduced by using the synthetic gas repository 30. Conversely, in a case in which an amount of fuel supplied to the combustor 2013 is too small, a flow of fuel may be increased by using the synthetic gas repository 30.

Although not shown in FIG. 2, a purified gas discharged from the exhaust gas purifier 40 in the daytime may be stored and utilized at night. That is, while the purified gas is being supplied to the SOC 10 at night, the SOC 10 may manufacture a synthetic gas by utilizing surplus electrical power of the second power plant 22.

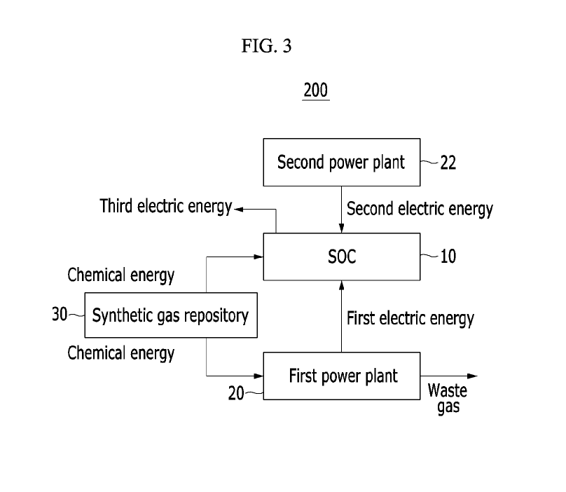

FIG. 3 is a schematic conceptual view of an SOC system 200 according to a second exemplary embodiment of the present invention. The structure of the SOC system 200 of FIG. 3 is merely illustrative, and the present invention is not limited thereto. Thus, the structure of the SOC system 200 may also be modified to have any other form. The SOC system 200 of FIG. 3 is similar to the SOC system 100 of FIG. 1, and thus the same reference numerals will be used for the same components and a detailed description thereof will be omitted.

As illustrated in FIG. 3, the SOC system 200 includes an SOC 10, a first power plant 20, a second power plant 22, and a synthetic gas repository 30. In addition, the SOC system 200 may further include other components as necessary.

The first power plant 20 discharges a waste gas and first electrical energy. The waste gas is discarded without being re-used. The SOC 10 receives chemical energy, i.e., carbon monoxide and hydrogen, from the synthetic gas repository 30, and provides third electrical energy. The first power plant 20 also receives chemical energy from the synthetic gas repository 30 and manufactures first electrical energy.

Meanwhile, the second power plant 22 provides second electrical energy to the SOC 10. The second electrical energy supplied from the second power plant 22 to the SOC 10 may not be uniform or may be slightly insufficient, and thus the first electrical energy may be additionally provided from the first power plant 20 to the SOC 10.

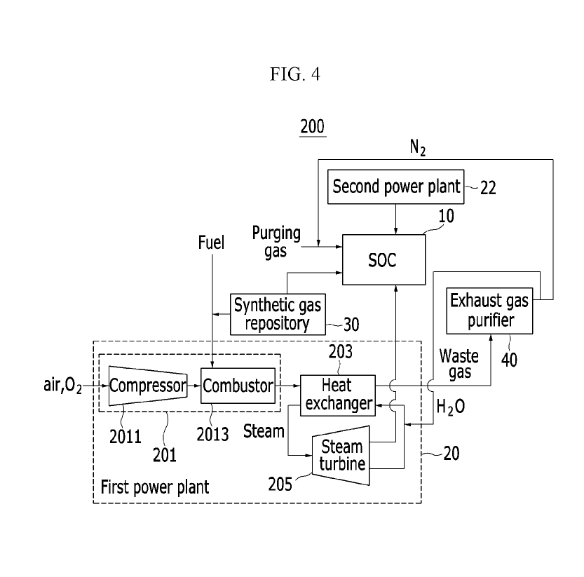

FIG. 4 is a schematic view illustrating an operational state of the SOC system 200 of FIG. 3. The operational state of the SOC system 200 illustrated in FIG. 4 specifies the operational state of the SOC system 200 of FIG. 3. The operational state of the SOC system 200 of FIG. 4 is merely illustrative, and the present invention is not limited thereto. Thus, the operational state of the SOC system 200 may be also modified to other forms. The SOC system 200 of FIG. 4 is similar to the SOC system 100 of FIG. 2, and thus the same reference numerals are used for the same components and a detailed description thereof will be omitted.

The SOC system 200 of FIG. 4 shows an operational state at night or in spring or autumn. That is, the SOC system 200 operates in the daytime when an amount of sunshine is equal to or greater than a preset value or when an atmospheric temperature is greater than or smaller than a preset range. In this case, demand for electrical power is great, and electrical energy may be produced by using the SOC 10 as a fuel cell. Here, the foregoing amount of sunshine and the foregoing preset range of atmospheric temperature range are the same as those of the SOC system 100 of FIG. 2 described above.

As illustrated in FIG. 4, the SOC 10 may produce electrical energy upon receiving electrical power required for driving a device from the second power plant 22 of the steam turbine 205 of the first power plant 20. To this end, the synthetic gas repository 30 may supply a synthetic gas as fuel to the SOC 10. The synthetic gas repository 30 may also supply a base material to the combustor 2013 of the first power plant 20. Through this process, the SOC 10 may produce electrical power. Meanwhile, since the SOC 10 may serve as a fuel cell, the exhaust gas purifier 40 may not need to supply steam and carbon dioxide obtained by purifying a waste gas to the SOC 10, and carbon monoxide and hydrogen are not generated in the SOC 10.

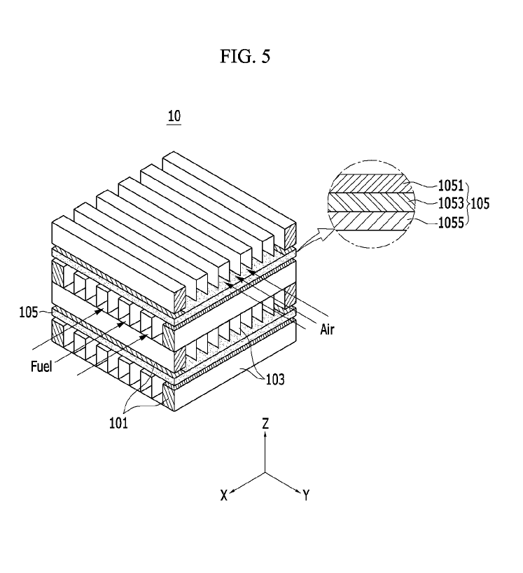

FIG. 5 is a schematic perspective view of the SOC 10 included in the SOC systems 100 and 200 (illustrated in FIGS. 1 through 4) according to the first and second exemplary embodiments of the present invention. A structure of the SOC 10 of FIG. 5 merely illustrates the present invention, and the present invention is not limited thereto. Thus, the structure of the SOC 10 may also be modified to have any other form.

As illustrated in FIG. 5, the SOC 10 includes a sealant 101, an interconnect 103, and a cell unit 105. In addition, the SOC 10 may further include any other components as necessary. Here, the SOC 10 may be reversibly used as an electrochemical cell or a fuel cell. Contents of reversible use of the SOC 10 may be easily understood by a person skilled in the art, and thus a detailed description thereof will be omitted.

First, as in the first exemplary embodiment of the present invention, in a case in which the SOC 10 is used as an electrochemical cell, air such as carbon dioxide and steam is introduced to the cell unit 105, converted into a fuel such as hydrogen and carbon monoxide, and subsequently discharged to the outside. The interconnect 103 is used to form a stack having large capacity by stacking a plurality of SOCs 10 in a z-axis direction. The interconnect 103 includes an upper interconnect attached to an upper portion of the cell unit 105 and a lower interconnect attached to a lower portion of the cell unit 105. Also, in order to form a stack by attaching the interconnects 103 stacked in the z-axis direction, the sealant 101 is applied to connect the interconnects 103. The sealant 101 is used to attach the interconnects 103 and the cell units 105. The sealant 101 serves to ensure airtightness such that fuel and air may not be mixed with each other.

As illustrated in the enlarged circular inset of FIG. 5, the cell unit 105 includes components such as a cathode 1051, an electrolyte 1053, and an anode 1055. These components are sequentially stacked with each other. The cathode 1051 and the anode 1055 may include a support. For example, the cell unit 105 may be used for mutual exchange between electrical energy and chemical energy, such as electrolysis. A fuel gas such as carbon dioxide and steam may be supplied to the anode 1055, and oxygen may be supplied to the cathode 1051. Here, the electrolyte 1053 may be formed of a material facilitating transfer of oxygen ions and minimizing a chemical reaction with an electrode material. The anode 1055 may include a catalyst. Carbon dioxide and steam supplied to the anode 1055 are decomposed in the cell unit 105 so as to be converted into carbon monoxide and hydrogen and subsequently discharged to the outside.

In the second exemplary embodiment of the present invention, in a case in which the SOC 10 is used as a fuel cell, a fuel such as carbon monoxide and hydrogen is introduced to the cell unit 105. Thus, electrical power may be produced by the SOC 10 by electrolyzing the fuel. In this case, in the enlarged circular inset of FIG. 5, a fuel gas such as carbon monoxide and hydrogen may be injected to the anode 1055, and oxygen may be supplied to the cathode 1051. Carbon monoxide and hydrogen supplied to the anode 1055 are used by being decomposed to produce electrical power in the cell unit 105.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

1. A solid oxide cell (SOC) system comprising:
a first power plant configured to provide a waste gas and first electrical energy;
a second power plant configured to provide second electrical energy using an energy source different from that of the first power plant; and
a solid oxide cell (SOC) connected to the first power plant and the second power plant, configured to receive the waste gas and the second electrical energy to manufacture carbon monoxide and hydrogen, and provide the carbon monoxide and the hydrogen to the first power plant.

2. The SOC system of claim 1, further comprising
a synthetic gas repository connected to the SOC and configured to store a synthetic gas manufactured by using the carbon monoxide and the hydrogen.

3. The SOC system of claim 1, wherein the second power plant is one or more selected from the group consisting of a solar power plant, a wind power plant, a geothermal power plant, a fuel cell power plant, and a tidal power plant, and the SOC receives the first electrical energy.

4. The SOC system of claim 1, wherein the first power plant comprises:
a gas turbine; and
a steam turbine connected to the gas turbine and configured to receive steam produced by waste heat of the gas turbine,
wherein the gas turbine comprises:
a compressor configured to take in air from the outside and provide compressed air; and
a combustor connected to the compressor to provide compressed air, and connected to the SOC to receive the carbon monoxide and the hydrogen from the SOC and combust the received carbon monoxide and hydrogen, and configured to discharge a combustion gas generated according to the combustion.

5. The SOC system of claim 4, further comprising
a heat exchanger configured to connect the gas turbine and the steam turbine, wherein the heat exchanger is connected to the combustor, configured to manufacture steam supplied to the steam turbine by the combustion gas, and connected to the SOC to supply the carbon dioxide and the steam to the SOC.

6. The SOC system of claim 5, wherein the waste gas is discharged from the steam turbine.

7. The SOC system of claim 5, further comprising
an exhaust gas purifier configured to connect the heat exchanger and the SOC, purify a waste gas discharged from the heat exchanger, and supply the purified gas to the SOC.

8. The SOC system of claim 7, wherein the exhaust gas purifier extracts nitrogen from the waste gas and provides the extracted nitrogen as a purging gas to the SOC.

9. A solid oxide cell (SOC) system comprising:
a first power plant configured to provide a waste gas and first electrical energy;
a second power plant configured to provide second electrical energy using an energy source different from that of the first power plant;
a solid oxide cell (SOC) connected to the first power plant and the second power plant, configured to receive second electrical energy, and providing third electrical energy; and
a synthetic gas repository connected to the first power plant and the SOC and configured to provide a synthetic gas to the first power plant and the SOC.

10. The SOC system of claim 9, wherein the SOC receives the first electrical energy.

11. A method for controlling a solid oxide cell (SOC) system, the method comprising:
providing, by a first power plant, a waste gas and first electrical energy;
providing, by a second power plant, second electrical energy by using an energy source different from that of the first power plant;
manufacturing, by a solid oxide cell (SOC) connected to the first power plant and the second power plant, carbon monoxide and hydrogen upon receiving the waste gas and the second electrical energy; and
providing, by the SOC, the manufactured carbon monoxide and the hydrogen to the first power plant.

12. The method of claim 11, further comprising
providing the first electrical energy to the SOC.

13. The method of claim 11, further comprising
storing, by the synthetic gas repository connected to the SOC, a synthetic gas manufactured by using the carbon monoxide and the hydrogen.

14. The method of claim 11, wherein in the manufacturing of carbon monoxide and hydrogen, the SOC operates when an amount of sunshine is less than a preset value.

15. The method of claim 11, wherein in the manufacturing of carbon monoxide and hydrogen, the SOC operates when an atmospheric temperature is within a preset range.

16. A method for controlling a solid oxide cell (SOC) system, the method comprising:
providing, by a first power plant, a waste gas and first electrical energy;
providing, by a second power plant, second electrical energy by using an energy source different from that of the first power plant;
receiving, by a solid oxide cell (SOC) connected to the first power plant and the second power plant, second electrical energy, and providing third electrical energy; and
providing, by a synthetic gas repository connected to the first power plant and the SOC, a synthetic gas to one or more of the first power plant and the SOC.

17. The method of claim 16, wherein in the providing of third electrical energy, the SOC operates when an amount of sunshine is equal to or greater than a preset value.

18. The method of claim 16, wherein in the providing of third electrical energy, the SOC operates when an atmospheric temperature is higher than or lower than a preset range.
